(19) United States
(12) Patent Application Publication
(10) Pub. No.: US 2021/0337402 A1
(43) Pub. Date: Oct. 28, 2021

(54) FIRST NETWORK NODE, THIRD NETWORK NODE, AND METHODS PERFORMED THEREBY HANDLING A MAINTENANCE OF A SECOND NETWORK NODE

(71) Applicant: Telefonaktiebolaget LM Ericsson (publ), Stockholm (SE)

(72) Inventors: Klaus Raizer, INDAIATUBA (BR); Björn Johannisson, KUNGSBACKA (SE); Alberto Hata, CAMPINAS-SP (BR)

(21) Appl. No.: 17/284,281

(22) PCT Filed: Oct. 11, 2018
(86) PCT No.: PCT/EP2018/077774

§ 371 Date: Apr. 9, 2021

(51) Int. Cl. H04W 24/02; H04L 12/24

(52) U.S. Cl. CPC H04W 24/02; H04L 41/145; H04L 41/147

(57) ABSTRACT

A method, performed by a first network node, for handling a maintenance of one or more second network nodes is described herein. The first network node and the one or more second network nodes operate in a communications network. The first network node obtains, respectively, from each of one or more third network nodes operating in the communications network, and for a respective second network node of the one or more second network nodes, one or more predictive models for each of: a) a performance of the respective second network node, and b) a traffic load of the respective second network node. The first network node then determines one or more plans to maintain the one or more second network nodes, based on the obtained one or more predictive models.

### TECHNICAL FIELD

The present disclosure relates generally to a first network node and methods performed thereby for handling a maintenance of a second network node. The present disclosure also relates generally to a third network node and methods performed thereby for handling the maintenance of the second network node.

### BACKGROUND

Wireless devices within a wireless communications network may be e.g., User Equipments (UE), stations (STAs), mobile terminals, wireless terminals, terminals, and/or Mobile Stations (MS). Wireless devices are enabled to communicate wirelessly in a communications network, cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The communications network covers a geographical area which may be divided into cell areas, each cell area being served by a network node, which may be an access node such as a radio network node, radio node or a base station, e.g., a Radio Base Station (RBS), which sometimes may be referred to as e.g., evolved Node B (“eNB”), “eNodeB”, “NodeB”, “B node”, gNB, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

Surveillance means of mobile communication RBSs have been in existence for a long time. When a failure occurs, one or more alarms may be triggered. The type of failures may then be analysed, and appropriate actions may be decided upon. Typically this may involve ordering a replacement of the equipment, if a radio failure occurs.

Recent and future generations of RBS products may have multiple radio chains, e.g., such as the Ericsson AIR product, and NR-arrays at high frequencies. With multiple radio chains, the outcome of a failure may differ from previous generation products. When a failure occurs in the RBS, e.g. a breakdown of a power amplifier, the equipment may typically not fail entirely, but instead the performance may gracefully degrade.

A challenging question for the maintenance organization responsible for the overall performance of a network may be considered to be when and what radio equipment may be most efficient to repair or replace, in terms of cost versus performance. Decisions may need to be taken not only based on the individual situation of the concerned RBS equipment, but also on the expected severity of the problem based on traffic situation, operational circumstances etc. . . .

Traditional maintenance strategies for RBS equipment repairs or replacements are based on radio fault messages. In many cases, maintenance strategies have been rather straight forward, as the radio equipment has been either working, and therefore no maintenance has been needed, or at fault, where immediate repair may be needed. To use this strategy for new generations of RBSs having graceful radio degradation characteristics will be both expensive and sub-optimal from a performance perspective. The reason may be understood to be that RBS products with multiple radio chains may not experience such a fast shift from working properly to severe fault or even total non-working condition, but instead may often realize a slower more graceful degradation of performance as more and more of the multiple radio chains fail or degrade. Radio chain faults may typically affect several performance factors, such as antenna gain, antenna beamform shape, output power, receiver sensitivity, and may in a total system perspective lead to effects on coverage, capacity and transmission latencies. Even when several of the radio chains may be at fault, the system performance of the RBS may however be reasonably good, depending on use cases and traffic conditions. But when too much radio chain errors occur, the performance is eventually affected. Here it may be understood to be important to plan the maintenance properly to ensure that repairs and replacements may be made in an effective way, prioritizing maintenance of equipment where overall system performance may be affected, but limit maintenance of equipment that may work well without too many performance problems.

### SUMMARY

It is an object of embodiments herein to improve the handling of maintenance of network nodes in a communications network.

According to a first aspect of embodiments herein, the object is achieved by a method, performed by a first network node. The method is for handling a maintenance of one or more second network nodes. The first network node and the one or more second network nodes operate in a communications network. The first network node obtains, respectively, from each of one or more third network nodes operating in the communications network, and for a respective second network node of the one or more second network nodes, one or more predictive models. The one or more predictive models are for each of: a) a performance of the respective second network node, and b) a traffic load of the respective second network node. The one or more first predictive models of the performance are based on one or more status messages obtained, from the respective second network node. The one or more first predictive models of the performance indicate at least one of: a number of data transmission failures, a number of dropped calls, or an area of blind spots. The first network node then determines one or more plans to maintain the one or more second network nodes. The determining is based on the obtained one or more predictive models.

According to a second aspect of embodiments herein, the object is achieved by a method, performed by a third network node. The method is for handling a maintenance of a second network node. The third network node and the second network node operate in the communications network. The third network node obtains the one or more predictive models. The one or more predictive models are for each of: a) a performance of the second network node, and a traffic load of the second network node. The one or more first predictive models of the performance are based on one or more status messages obtained from the second network node. The one or more first predictive models of the performance indicate at least one of: a number of data transmission failures, a number of dropped calls, or an area of blind spots. The third network node then sends the obtained one or more predictive models to the first network node operating in the communications network.

According to a third aspect of embodiments herein, the object is achieved by a first network node. The first network node is configured to handle the maintenance of one or more second network nodes. The first network node and the one or more second network nodes are configured to operate in the communications network. The first network node is configured to obtain, respectively, from each of one or more third network nodes configured to operate in the communications network, and for a respective second network node of the one or more second network nodes the one or more predictive models. The one or more predictive models are for each of: a) the performance of the respective second network node, and b) the traffic load of the respective second network node. The one or more first predictive models of the performance are configured to be based on the one or more status messages configured to be obtained, from the respective second network node. The one or more first predictive models of the performance are configured to indicate at least one of: the number of data transmission failures, the number of dropped calls, or the area of blind spots. The first network node is further configured to determine the one or more plans to maintain the one or more second network nodes. The determining is configured to be based on the one or more predictive models configured to be obtained.

According to a fourth aspect of embodiments herein, the object is achieved by a third network node, configured to handle the maintenance of the second network node. The third network node and the second network node are configured to operate in the communications network. The third network node is further configured to obtain the one or more predictive models for each of: a) the performance of the second network node, and b) the traffic load of the second network node. The one or more first predictive models of the performance are configured to be based on the one or more status messages obtained from the second network node. The one or more first predictive models of the performance indicate at least one of: the number of data transmission failures, the number of dropped calls, or the area of blind spots. The third network node is also configured to send the one or more predictive models configured to be obtained to the first network node configured to operate in the communications network.

By the first network node obtaining the one or more predictive models, the first network node is enabled to learn information about the impact of equipment maintenance at the one or more second network nodes, and to then use this information to determine the one or more plans to maintain the one or more second network nodes, to reduce expected negative impacts on the communications network due to maintenance. The third network node, by obtaining the one or more predictive models is enabled to learn, in an automatic fashion, the behavior of the second network node, and determine the parameters that may be affecting its performance. Those parameters coming from different third network nodes, may then be used by the first network node to generate the one or more predictive models in order to maximize the performance of the communications network. Overall, radio resources, energy and/or processing resources may be saved. Moreover, from a total system perspective this may also lead to that latency may be prevented from becoming worse.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications network, according to embodiments herein.

FIG. 2 is a flowchart depicting a method in a first network node, according to embodiments herein.

FIG. 3 is a flowchart depicting a method in a third network node, according to embodiments herein.

FIG. 4 is a schematic diagram of a predictive model of status messages from network components, according to embodiments herein.

FIG. 5 is a schematic diagram of a predictive model of performance of a network node based on status messages, according to embodiments herein.

FIG. 6 is a schematic diagram of a predictive model of traffic load, according to embodiments herein.

FIG. 7 is a schematic diagram of a predictive model of a determining action performed by the first network node, according to embodiments herein.

FIG. 8 is a signalling diagram of interactions between the first network node, the second network node, the third network node and a fourth network node, according to embodiments herein.

FIG. 9 is a schematic block diagram illustrating embodiments of a first network node, according to embodiments herein.

FIG. 10 is a schematic block diagram illustrating embodiments of a second wireless device, according to embodiments herein.

### DETAILED DESCRIPTION

As part of developing embodiments herein, certain challenge(s) that currently exist and may be associated with use of at least some of the existing methods, and that may be addressed by embodiments herein, will first be identified and discussed.

As stated earlier, use of existing methods for new generations of RBSs having, e.g., multiple radio chains will be both expensive and sub-optimal from a performance perspective. This may be understood to be because equipment having e.g., multiple radio chains, may not be as seriously affected by a fault in one of the radio chains, as the other radio chains may be able to still provide service. Therefore maintenance may be able to be deferred until performance of the equipment is more seriously impacted. This may represent savings, and fewer service disruptions.

Certain aspects of the present disclosure and their embodiments may provide solutions to the challenges discussed earlier. There are, proposed herein, various embodiments which address one or more of the issues disclosed herein. As a general overview, embodiments herein may be understood to relate to a Machine Learning (ML) method for improving RBS radio maintenance. Embodiments herein may be understood to be drawn at a method for learning relevant information about the impact of equipment maintenance at RBS sites, and to then use this information to generate relevant maintenance plans, for example, by means of multi-objective optimization, that may reduce the negative impact on the network. An individual agent may be assigned to each RBS to learn the behavior of the equipment, and determine the parameters that may be affecting their performance. These parameters coming from different agents may then be used in an optimization model that may generate a set of RBS configuration setups that maximizes the performance.

Several embodiments and examples are comprised herein. It should be noted that the embodiments and/or examples herein are not mutually exclusive. Components from one embodiment or example may be tacitly assumed to be present in another embodiment or example and it will be obvious to a person skilled in the art how those components may be used in the other exemplary embodiments and/or examples.

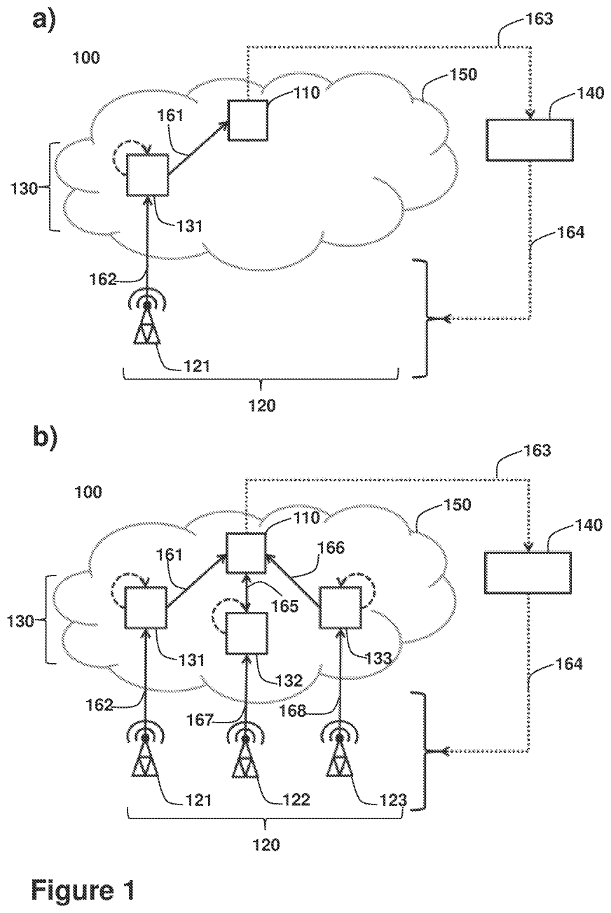

FIG. 1 depicts two non-limiting examples, in panels a) and b), respectively, of a communications network 100, sometimes also referred to as a wireless communications network, communication system, wireless communications system, cellular radio system, or cellular network, in which embodiments herein may be implemented. The communications network 100 may typically be a Long-Term Evolution (LTE), e.g., LTE Frequency Division Duplex (FDD), LTE Time Division Duplex (TDD), LTE Half-Duplex Frequency Division Duplex (HD-FDD), LTE operating in an unlicensed band, or a 5G system, 5G network, or Next Gen System or network. The communications network 100 may also support other technologies such as, for example, a Wide Code Division Multiplexing Access (WCDMA), Universal Terrestrial Radio Access (UTRA) TDD, Global System for Mobile Communications (GSM) network, GSM Enhanced Data rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 3GPP LTE has been used in this disclosure to exemplify embodiments herein, this should not be seen as limiting the scope of the embodiments herein to only the aforementioned system. Other wireless systems, especially 5G/NR, WCDMA, WiMax, UMB and GSM, may also benefit from exploiting the ideas covered within this disclosure.

The communications network 100 comprises a first network node 110, one or more second network nodes 120, one or more third network nodes 130, and a fourth network node 140.

The one or more second network nodes 120, in the non-limiting example of FIG. 1, panel b), comprise a second network node 121, a second second network node 122, and a third second network node 123. However, the number of second network nodes depicted in panel b) is for illustration purposes only. It may be understood that any description provided herein for the second network node 121 may equally apply to any of the other second network nodes in the one or more second network nodes 120.

The one or more second third network nodes 130, in the non-limiting example of FIG. 1, panel b), comprise a third network node 131, a second third network node 132, and a third third network node 133. However, the number of third network nodes depicted in panel b) is for illustration purposes only. It may be understood that any description provided herein for the third network node 131 may equally apply to any of the other third network nodes in the one or more third network nodes 130.

The first network node 110 and the one or more third network nodes 130 may be core network nodes. In some examples, such as those depicted in FIG. 1, the first network node 110 and the one or more third network nodes 130 may be in the cloud 150. In LTE and in 5G, for example, the first network node 110 and the one or more third network nodes 130 may be located in the OSS (Operations Support Systems).

Each of the one or more second network nodes 120 may be another core network node, or, as depicted in the example of FIG. 1, a radio network node e.g., a base station, as described further below.

Each of the one or more third network nodes 130 may be understood to have a respective second network node among the one or more second network nodes 120. In the non-limiting example of FIG. 1, the second network node 121 is the respective second network node of the third network node 131, the second second network node 122 is the respective second network node of the second third network node 132, and the third second network node 123 is the respective second network node of the third third network node 133. Expressed differently, each second network node, e.g., an RBS, may have a respective agent.

In some examples, of the one or more third network nodes 130 may be understood to be co-localized, or be the same node as its respective second network node.

The fourth network node 140 may be a computer system, which may be located outside of the core network of the communications network 100, but which may be able to communicate with it through a wireless or wired connection.

In some examples, the first network node 110 and any or all of the one or more third network nodes 130 may be co-localized, or be the same node.

In some examples, the first network node 110, the second network node 121 and the third network node 131 may be co-localized, or be the same node.

In other examples which are not depicted in FIG. 1, any of the first network node 110, the one or more second network nodes 120, the one or more third network nodes 130, and the fourth network node 140 may be a distributed node, such as a virtual node in the cloud 150, and may perform its functions entirely on the cloud 150, or partially, in collaboration with a radio network node.

Any of the one or more second network nodes 120 may be a radio network node, such as a transmission point or a radio base station, for example an eNB, eNodeB, Home Node B, Home eNode B, gNB, multi-standard radio (MSR) radio node such as MSR BS, network controller, radio network controller (RNC), base station controller, relay, donor node controlling relay, base transceiver station (BTS), access point (AP), transmission node, Remote Radio Unit (RRU), Remote Radio Head (RRH), nodes in distributed antenna system (DAS), or any other network node with similar features capable of serving a wireless device, such as a user equipment or a machine type communication device, in the communications network 100. Any of the one or more second network nodes 120 may be of different classes, such as, e.g., macro base station, home base station or pico base station, based on transmission power and thereby also cell size. Any of the one or more second network nodes 120 may support one or several communication technologies, and its name may depend on the technology and terminology used. In LTE, any of the one or more second network nodes 120 may be referred to as an eNB. In 5G/NR, any of the one or more second network nodes 120 may be referred to as a gNB and may be directly connected to one or more core networks, which are not depicted in its entirety in FIG. 1. In some examples, e.g., in New Radio (NR), any of the one or more second network nodes 120 may serve receiving nodes, such as wireless devices, with a plurality of beams.

The communications network 100 covers a geographical area which may be divided into cell areas, wherein each cell area may be served by a radio network node, although, one radio network node may serve one or several cells. In the non-limiting example depicted in FIG. 1, the cells are not depicted to simplify the Figure.

A plurality of wireless devices may be located in the communications network 100, although these are not depicted to simplify the Figure. Any of the wireless devices comprised in the communications network 100 may be a wireless communication device such as a UE, or a 5G UE, which may also be known as e.g., mobile terminal, wireless terminal and/or mobile station, a mobile telephone, cellular telephone, or laptop with wireless capability, just to mention some further examples. Any of the wireless devices comprised in the communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet computer, sometimes referred to as a tablet with wireless capability, Machine-to-Machine (M2M) device, device equipped with a wireless interface, such as a printer or a file storage device, modem, or any other radio network unit capable of communicating over a radio link in a communications system. Any of the wireless devices comprised in the communications network 100 may be enabled to communicate wirelessly in the communications network 100. The communication may be performed e.g., via a RAN, and possibly the one or more core networks, which may comprised within the communications network 100.

The first network node 110 may be configured to communicate within the communications network 100 with the third network node 131 over a first link 161. The second network node 121 may be configured to communicate within the communications network 100 with the third network node 131 over a second link 162. The first network node 110 may be configured to communicate within the communications network 100 with the fourth network node 140 over a third link 163. The fourth network node 140 may be configured to communicate within the communications network 100 with any of the one or more second network nodes 120 over a respective fourth link 164. The first network node 110 may be configured to communicate within the communications network 100 with the second third network node 132 over a fifth link 165. The first network node 110 may be configured to communicate within the communications network 100 with the third third network node 133 over a sixth link 166. The second third network node 132 may be configured to communicate within the communications network 100 with the second second network node 122 over a seventh link 167. The third third network node 133 may be configured to communicate within the communications network 100 with the third second network node 123 over an eighth link 168.

Any of the links just mentioned may be, e.g., a radio link or a wired link.

In general, the usage of “first”, “second”, “third”, “fourth”, “fifth”, “sixth”, “seventh” and/or “eighth” herein may be understood to be an arbitrary way to denote different elements or entities, and may be understood to not confer a cumulative or chronological character to the nouns they modify.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

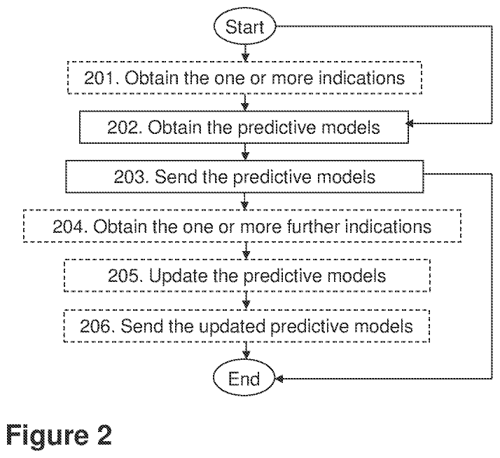

Embodiments of a method, performed by the third network node 131, will now be described with reference to the flowchart depicted in FIG. 2. The method is for handling a maintenance of the second network node 121. The third network node 131 and the second network node 121 operate in the communications network 100.

Several embodiments are comprised herein. In some embodiments all the actions may be performed. In some embodiments, one or more actions may be optional. In FIG. 2, optional actions are indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. Some actions may be performed in a different order than that shown in FIG. 2.

Action 201

During the course of operations in the communications network 100, one or more elements in the second network node 121 may fail. Especially in the case that the second network node 121 may comprise multiple radio chains, it may not always be necessary to trigger the maintenance of second network node 121. In order to determine if it may be necessary to maintain the second network node 121, and if so, when, that is, in order to enable a determination of one or more plans to maintain the second network node 121, the third network node 131 may monitor reports that may be generated by the second network node 121, that is, its respective second network node. The reports may comprise status messages coming from the second network node 121. The third network node 131 may collect the reports from the second network node 121, and filter the relevant information. The third network node 131 may later, based on the collected information, attempt to learn, e.g., via Machine Learning (ML), the causal relations between equipment maintenance, status reports, performance degradation and traffic profile.

In accordance with this, in this Action 201, the third network node 131 may obtain, from the second network node 121 one or more indications of: i) a maintenance status of one or more components of the second network node 121, ii) one or more status messages received from the second network node 121; or iii) a traffic load of the second network node 121.

Obtaining may be understood as e.g., collecting or receiving, e.g., via the second link 162.

The one or more indications may be understood as e.g., one or more reports.

The one or more components may be understood as hardware, software or a combination of hardware and software components.

The maintenance status of the one or more components may be understood as whether or not the one or more components, or the equipment, of the second network node 121 may be currently under maintenance, that is, whether or not the one or more components are being repaired. “Currently” may be understood as referring to the time point when Action 201 may be performed. An indication of the maintenance status of the one or more components of the second network node 121 may be obtained, for example, as a Boolean vector “e”.

A status message may be understood as, e.g. the General Error Situation Report in X2 Application Protocol (X2AP). The one or more status messages received from the second network node 121 may be obtained, for example, as a Boolean vector “m”.

The traffic load of the second network node 121 may be understood as a real number reflecting, e.g. the Load Indication and Resource Status Request in X2 Application Protocol (X2AP).

By performing this Action 201, the third network node 131 may be enabled to obtain one or more predictive models for each of the performance of the second network node 121 and the traffic load, as described in the next Action 202.

The third network node 131 may also obtain a location of the second network node 121.

A predictive model may be understood as a mathematical model or function that aims at best fit a set of data, such that inputting observed data, it may output predicted or estimated data.

It may be understood that each of the one or more second network nodes 120, or sites, comprised in the communications network 100 may comprise its own set of equipment that may need to be maintained at some point in time. Each of the one or more third network nodes 130 may be understood to similarly obtain, for each of the respective second network nodes 121, 122, 123 of the one or more second network nodes 120, respectively, one or more indications of: the maintenance status of their respective one or more components, ii) one or more status messages respectively received by each of the one or more second network nodes 120; or iii) the respective traffic load of each of the one or more second network nodes 120. Any of the third network node 131, the second third network node 132 or the third third network node 133 may be referred to herein as an agent. To express the foregoing in other words, each agent may receive the one or more indications, from its corresponding site or respective second network node.

Action 202

The third network node 131 may use the obtained one or more indications to build one or more predictive models that may find relations, e.g., correlations, in the reported data, such as a relationship between equipment model, location, and maintenance status. The obtained one or more predictive models may act like a profile of the second network node 121. At least two models may be obtained. The first one may be understood to be related to the performance of the second network node 121. The second one may be understood to be related to the traffic profile of the second network node 121.

According to the foregoing, in this Action 202, the third network node 131 obtains one or more predictive models for each of: a) a performance of the second network node 121, and b) a traffic load of the second network node 121. One or more first predictive models of the performance are based on the one or more status messages obtained from the second network node 121. The one or more first predictive models of the performance indicate at least one of: a number of data transmission failures, a number of dropped calls, or an area of blind spots.

Obtaining in this Action 202 may be understood as determining, calculating, deriving, and in some examples, retrieving from a memory, or receiving from another source. The obtaining in this Action 202 may be performed with e.g., machine learning techniques, such as for example artificial neural networks, decision trees and random forests. However, in some examples, the obtaining in this Action 202 may be performed by consulting simple tables.

The obtaining of the one or more predictive models will now be described in more detail.

Performance

The performance may be understood to refer to indicators of performance, e.g., Key Performance Indicators (KPIs), such as the number of data transmission failures, the number of dropped calls, or the area of blind spots. A transmission failure may be considered to occur when, for example, a data package could not be received or delivered by a UE.

A dropped call may be considered to occur when, for example, a call was ended due to a network connectivity issue.

A blind spot may be understood as an area that is supposed to be covered by an RBSs, but where there is not enough network coverage, e.g. due to signal interference or high path loss.

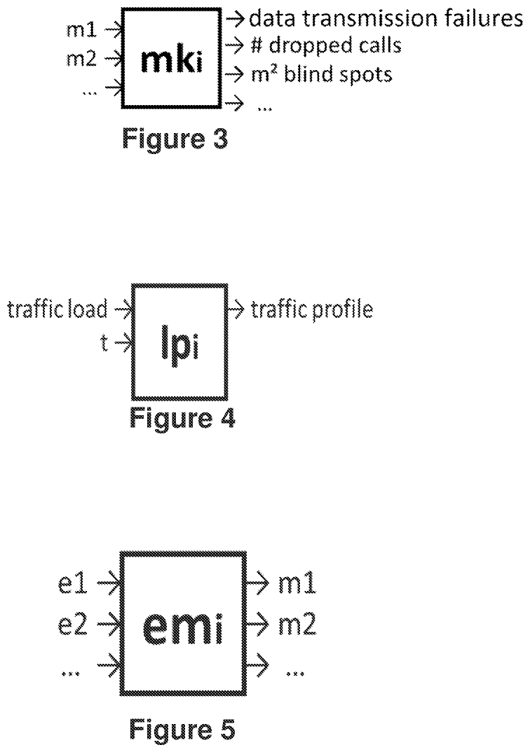

In some examples, the one or more predictive models for the performance of the second network node 121 may be obtained, or built, by receiving status messages from the second network node 121 as input, as well as the indicators of performance collected from the second network node 121, and outputting, with the built predictive model, the expected or predicted effects in performance in terms of dropped calls, area of blind spots and other KPIs. FIG. 3 is a schematic illustration depicting an example of such a predictive model. As depicted in FIG. 3, the status messages “m” from the second network node 121, which may be considered a site Si, are represented as message 1 “m1”, message 2 “m2”, etc. . . . . This predictive model may be understood to aim at predicting the data transmission failures, the number of dropped calls, the area of blind spots, and other KPIs, which may be collectively referred to as “k”. Hence, this predictive model, may be referred to as the “mki model”. To build this model, a machine learning method may be used, such as artificial neural networks and Long Short-Term Memory (LSTM). Therefore, the inputs of the model may be the messages, e.g., m1, m2, . . . and the outputs of the model may be the KPIs, such as the number of dropped calls, blind spot area.

In other examples, the one or more predictive models for the performance of the second network node 121 may be obtained by receiving a list of the one or more components of the second network node 121 that may be currently under maintenance, e.g., as a vector of Booleans, or other numerical values, and outputting the expected effects in performance in terms of dropped calls, area of blind spots and other KPIs.

Traffic Load

The one or more predictive models for the traffic load may be obtained, for example, as a regression model that may learn the probable traffic load at a given time of the day for the second network node 121, based on historical traffic loads recorded by the third network node 131. Examples of machine learning methods that may be used for this task may be artificial neural networks, random forests and gradient boosting.

FIG. 4 is a schematic illustration depicting an example of such a predictive model. As depicted in FIG. 4, the observed traffic load from the second network node 121 at a given time of the day “t” is used as input to aim at predicting the probable traffic load at a given time of the day for the second network node 121. This predictive model may be referred to as the “lpi model”.

In some embodiments, at least three predictive models may be obtained in this Action 202. In addition to the two one or more predictive models already mentioned, a third one or more predictive model may be understood to be related to the maintenance status of the equipment. Accordingly, in some embodiments, the one or more predictive models may further comprise one or more second predictive models for the status messages that may be received from by the second network node 121. The one or more second predictive models for the status messages may be based on the maintenance status of the one or more components of the second network node 121.

Status Messages

The one or more predictive models for the status messages may be obtained by receiving a list of the one or more components “e” of the second network node 121 that are currently under maintenance, e.g., as a vector of Booleans, as well as the status messages “m” collected from the second network node 121 during the time when the one or more components “e” of the second network node 121 are under maintenance, and outputting the status messages that may be expected for when such maintenance happens in the future. An example of such input may be [0,0,1,0,1], which means that the 3^{rd} and 5^{th} equipment may be under maintenance, where each vector position represents a specific equipment. This model may be automatically learned, or received from a domain expert.

FIG. 5 is a schematic illustration depicting an example of such a predictive model. As depicted in FIG. 5, the one or more components “m” from the second network node 121, which may be considered a site Si, are represented as equipment 1 “e1”, equipment 2 “e2”, etc. . . . . This predictive model may be understood to aim at predicting the status messages “m” that may be obtained when the one or more components “e” are under maintenance. Hence, this predictive model may be referred to as the “emi model”.

In embodiments wherein the at least three predictive models may be obtained in this Action 202, the one or more predictive models for the performance of the second network node 121 may be obtained by receiving the status messages as input, and outputting the expected effects in performance in terms of the dropped calls, the area of blind spots and the other KPIs.

Similarly to what was described in Action 201, it may be understood that each of one or more third network nodes 130 may similarly obtain for a respective second network node of the one or more second network nodes 120, one or more predictive models or the performance of the respective second network node, and the traffic load of the respective second network node. Expressed differently, each of one or more third network nodes 130 may similarly obtain for a respective second network node of the one or more second network nodes 120, respective one or more predictive models or the respective performance of the respective second network node, and the respective traffic load of the respective second network node, as described here for the third network node 131, with respect to the second network node 121.

The usage of agents may be understood to enable learning, in an automatic fashion, of the one or more predictive models related to the performance of the respective second network nodes 121, 122, 123, and the equipment status based on the one or more indications provided by the respective second network nodes 121, 122, 123.

In some examples, the third network node 131 may itself obtain the respective one or more predictive models for each of: a) a respective performance of the one or more second network nodes 120, wherein one or more respective first predictive models of the performance may be based on one or more respective status messages respectively obtained from the one or more second network nodes 120; in such embodiments, the one or more respective first predictive models of the performance may indicate at least one of: a respective number of data transmission failures, a respective number of dropped calls, or a respective area of blind spots; or b) a respective traffic load of the one or more second network nodes 120.

Accordingly, it may be understood that every model, emi, mki, lpi for a respective second network node of the one or more second network nodes 120, or Site Si, may be learned from data collected by a respective third network node of the one or more third network nodes 130, or agent “Ai”. The advantage of having a respective third network node for every second network node may be understood to be that they may be decoupled from each other, not requiring the same set of resources. It may also be an advantage to be able to parallelize obtaining the models emi, mki and lpi and have specialized models for each second network node.

Action 203

Once the third network node 131 has obtained the one or more predictive models, in this Action 203, the third network node 131 sends the obtained one or more predictive models to the first network node 110 operating in the communications network 100.

The sending in this Action 203 may be implemented, for example, via the first link 161. The models may be sent to the first network node 110 using a communication protocol, such as, e.g., TCP/IP or REST calls.

The third network node 131 may also provide the location of the second network node 121 to the first network node 110.

By sending the one or more predictive models in this Action 203, the third network node 131 may enable the first network node 110 to use the one or more predictive models, for example, to determine one or more plans to maintain the second network node 121 or the one or more second network nodes 120.

Action 204

The learning system implemented by the third network node 131, or any of the second third network node 132, and the third third network node 133, may enable to process a large amount of data, update the one or more predictive models continuously and use historical information of the communications network 100.

Accordingly, with the passage of time, in this Action 204, the third network node 131 may obtain, from the second network node 121, one or more further indications of: i) the maintenance status of the one or more components of the second network node 121, ii) the one or more status messages received from the second network node 121; or iii) the traffic load of the second network node 121.

Further indications may be understood as additional, or new indications.

Obtaining may be understood as e.g., collecting or receiving, e.g., via the second link 162.

By receiving the one or more further indications in this Action 204, the third network node 131 may be enabled to update the obtained one or more predictive models, that is, to improve their predictive power.

Action 205

In this Action 205, the third network node 131 may update the obtained one or more predictive models with the obtained one or more further indications. That is, the third network node 131 may improve the predictive power of the one or more predictive models, as new data are collected by the second network node 121 and provided to the third network node 131.

Action 206

In this Action 206, the third network node 131 may send the updated one or more predictive models to the first network node 110.

The sending in this Action 206 may be implemented, for example, via the first link 161.

By sending the updated one or more predictive models in this Action 206, the third network node 131 may enable the first network node 110 to use the improved one or more predictive models and, for example, determine one or more plans to maintain the second network node 121 with improved adequacy for the overall performance of the communications network 100.

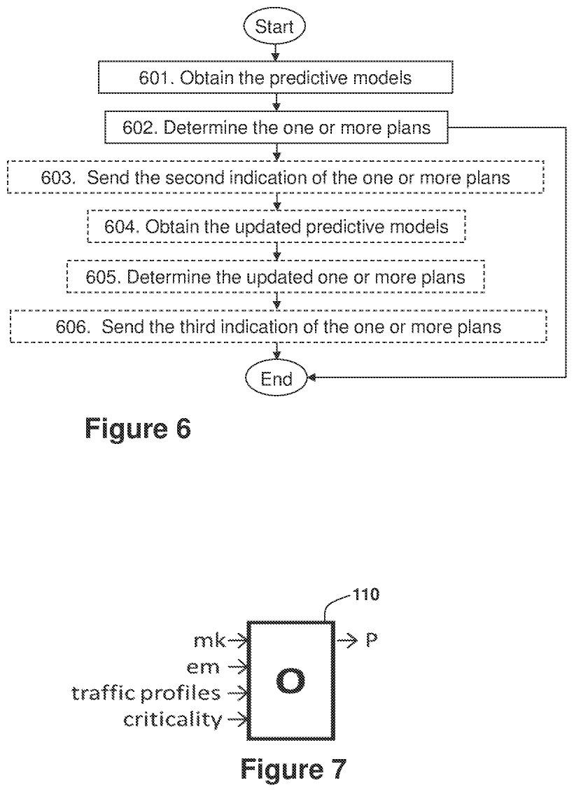

Embodiments of a method, performed by the first network node 110, will now be described with reference to the flowchart depicted in FIG. 6. The method is for handling the maintenance of the one or more second network nodes 120. The first network node 110 and the one or more second network nodes 120 operate in the communications network 100.

Several embodiments are comprised herein. In some embodiments all the actions may be performed. In some embodiments, one or more actions may be optional. In FIG. 6, optional actions are indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. Some actions may be performed in a different order than that shown in FIG. 6.

The detailed description of some of the following corresponds to the same references provided above, in relation to the actions described for the third network node 131, and will thus not be repeated here to simplify the description, however, it applies equally. For example, each of the one or more third network nodes 130, or agent, may have a respective second network node, such as the third network node 131, the second third network node 132, and the third third network node 133.

Action 601

In this Action 601, the first network node 110 obtains, respectively, from each of the one or more third network nodes 130 operating in the communications network 100, and for a respective second network node of the one or more second network nodes 120, the one or more predictive models for each of: a) the performance of the respective second network node, e.g., the mki model, and b) the traffic load of the of the respective second network node, e.g., the lpi model, as described in Action 202 for the third network node 131. The one or more first predictive models of the performance are based on the one or more status messages obtained from the from the respective second network node. The one or more first predictive models of the performance indicate at least one of: the number of data transmission failures, the number of dropped calls, or the area of blind spots,

In other words, the first network node 110 may obtain, from either the third network node 131 or each of the third network node 131, the second third network node 132 or the third third network node 133, respective one or more predictive models. The respective one or more predictive models may be understood to be for each of: a) the respective performance of the respective second network node of the one or more second network nodes 120, wherein one or more respective first predictive models of the performance may be based on one or more respective status messages respectively obtained from the respective second network node of the one or more second network nodes 120; or b) the respective traffic load of the respective second network node of the one or more second network nodes 120. The one or more respective first predictive models of the performance may indicate at least one of: the respective number of data transmission failures, the respective number of dropped calls, or the respective area of blind spots for the respective second network node of the one or more second network nodes 120.

The receiving in this Action 601 may be performed, for example, via the first link 161, the fifth link 165, and the sixth link 166.

As described earlier, in some embodiments, the one or more predictive models may further comprise the one or more second predictive models for the status messages that may have been received from the respective second network node. The one or more second predictive models for the status messages, e.g., the emi model, may be based on the maintenance status of the one or more components of the received from the respective second network node.

The obtaining of the one or more predictive models in this Action 601 may be understood to enable the first network node 110 to obtain one or more plans to maintain the one or more second network nodes 120, as described in the next Action 602.

Action 602

The first network node 110 may therefore be understood as an optimizer “O”, that is, an optimizer agent that may propose a maintenance one or more plans (P) to maintain the one or more second network nodes 120 that may improve the KPIs of the communications network 100. The first network node 110 may do so based on the information learned by the one or more third network nodes 130, that is, the agents “A”.

In this Action 602, the first network node 110 determines one or more plans to maintain the one or more second network nodes 120. The determining in this Action 602 is based on the obtained one or more predictive models.

Determining in this Action 602 may be understood as obtaining, calculating, or deriving.

A plan may be understood as a set of actions, that is, maintenance procedures that may need to be performed at one or more RBSs. These actions may be performed by a human or in an automatic way. This plan may be represented as a vector, but other representations may be used. An example of vector representation may be: P=[T1 S2 e2 e4 T3 S5 e0 e1 e2 T1 S5 e2], which means that team 1 (T1) is sent to site 2 (S2) to perform maintenance on equipment 2 and 4 (e2, e4). Concurrently, Team 3 is sent to site 5 for performing maintenance on equipment 0, 1 and 2. After finishing at site 1, team 1 is sent to site 5 to perform maintenance at equipment 2.

In some embodiments, based on the obtained one or more predictive models, the determining in this Action 602 may comprise applying a multi-objective optimization algorithm, such as, e.g., NSGA2 or SPEA2. The determining in this Action 602 may be implemented by building a multi-objective optimization problem using the one or more predictive models obtained from the one or more third network nodes 130.

An objective function may be modeled aiming to optimize the one or more plans to maintain the one or more second network nodes 120 considering the one or more predictive models learned from the one or more third network nodes 130. In this sense, the objective function may be formed by the KPIs related to the maintenance, performance, and traffic profile of the one or more second network nodes 120.

The solutions, at pareto frontier, of the multi-objective problem may then be evaluated to select the one that fits the current situation.

In some embodiments, based on the obtained one or more predictive models, the determining in this Action 602 may comprise applying a multi-objective optimization algorithm, wherein the application of the multi-objective optimization algorithm may simultaneously: a) minimize the number of data transmission failures, or the number of dropped calls, and the area of blind spots; and b) maximize the traffic load.

The optimization procedure may be understood to, based on the received obtained one or more predictive models, produce one or more maintenance plans that may take into account the possible effects of performing maintenance at a specific equipment, on all of the one or more second network nodes 120, given their traffic profiles. That is, the possible effects of performing maintenance, in some particular examples, at the second network node 121, on the other one or more second network nodes 120, such as the second second network node 122 and the third second network node 123, given their traffic profiles.

The KPIs to be optimized by the first network node 110 may be preferably calculated as follows.

The number of data transmission failures, or the number of dropped calls, may be based on a first weighted sum of the number of data transmission failures, or of the number of dropped calls, at each of the one or more second network nodes 120 during a first period of time. The first weighted sum may be based on a criticality of the one or more second network nodes 120.

As an example, the number of dropped calls “D” may be calculated according to the following formula:

$$D = {\sum }_{i = 0}^{n} {c}_{i} * {d}_{i}$$

That is, the number of dropped calls “D” may be calculated as a weighted sum of dropped calls at each site “i” at an arbitrary period of time, e.g., from t0 to tf, where the weights ci may be understood as measures of how critical each site is. For instance, for a period of one day, if the communications network 100 has two sites, i.e. S0, S1, and site 1 is twice as critical as site 0, i.e. c0=1 and c1=2. Assuming site S0 recorded 100 drops and S1 recorded 600 drops during the period, D=1*100+2*600=700.

The area of blind spots may be based on a second weighted sum of blind spots at each of the one or more second network nodes 120 during a second period of time. The second weighted sum may be based on the criticality of the one or more second network nodes 120. The second period of time may, in typical examples, be the same as the first period of time, although this may not be necessarily the case.

As an example, the area of Blind spots “B” may be calculated according to the following formula:

$$B = {\sum }_{i = 0}^{n} {c}_{i} * {b}_{i}$$

That is, the area of Blind spots “B” may be calculated in the same manner as the number of dropped calls. But instead of summing up the number of dropped calls, the first network node 110 may calculate the weighted sum of detected blind spots areas “bi”.

The traffic impact “T” may be understood as a measure of how badly the maintenance of equipment at the one or more second network nodes 120 may affect traffic load.

The traffic impact “T” may be calculated according to the following formula:

$$T = {\sum }_{i = 0}^{n} {c}_{i} * {\int }_{to}^{t f} m ( t ) * l {p}_{i} ( t ) \\ m ( t ) = \{ \begin{matrix}0 if any element of {e}_{i} = 1 at time t \\ 1 otherwise\end{matrix}$$

The integral of lpi(t) may be understood to give a predicted amount of traffic for site Si from t0 to tf, which may be a day. For example, if any equipment is under maintenance at time t, the integral will be zero, which means no traffic is going through Si due to maintenance.

The optimization process may be understood to comprise applying a multi-objective optimization algorithm, such as NSGA2 or SPEA2, to simultaneously minimize D, and B, and maximize T. This optimization process may be understood to generate several plans, each at a different point near the pareto surface. The fourth network node 140, which may be understood as a decision-maker node, or, alternatively, a human being may then responsible for choosing the most appropriate plan and issuing it to the maintenance team.

In some embodiments, the determined one or more plans may comprise one or more first indications of a set of the one or more components requiring maintenance.

The first network node 110 may also need information about the geographical position of the one or more second network nodes 120, a current position of available maintenance teams, and a criticality (C) of each of the one or more second network nodes 120. The criticality, e.g., “C”, may be understood as a number between 0 and 1, which may be arbitrarily defined based on how critical a given site may be. For example, if it provides service to a hospital area it may be set as 1, but if it provides service to rural area without many people it may be set as 0.2.

These KPI calculation formulas may be used by the first network node 110 for evaluation of how good possible plans may be. The plans with low dropped calls (D), lower values for blind spots (B) and lower traffic impact (T) may be preferred by the first network node 110, while plans with higher dropped calls, higher values for blind spots and higher values for traffic impact may not be desired by the first network node 110. Which plans may be preferred may be defined in more detail by the multi-objective optimization algorithm that may be used, e.g., NSGA2.

The obtained one or more predictive models may be used to estimate the impact of the one or more plans on overall performance.

According to the foregoing, in some embodiments, the determining in this Action 602 of the one or more plans may be further based on one or more of: a) a geographical position of the one or more second network nodes 120, b) a position of the one or more second network nodes 120 relative, respectively, to a position of other radio network nodes operating in the communications network 100; or c) the criticality of the one or more second network nodes 120.

The position of the one or more second network nodes 120 relative, respectively, to the position of other radio network nodes, may be understood to indicate a density of RBSs in an area, which may in turn be understood to have an impact on the criticality for that part of the network. For example, if there are neighbouring RBSs that may take over traffic from a problem RBS, the problem RBS may be less critical.

Action 603

In some embodiments, the first network node 110 may send a second indication of the determined one or more plans to the fourth network node 140 operating in the communications network 100.

The sending in this Action 603 may be implemented, e.g., via the third link 163.

The fourth network node 140 may be, in some examples, a decision-maker node, which may itself be responsible for approving and dispatching the maintenance team (M) to implement the one or more plans “P” devised by the first network node 110. In other examples, the fourth network node 140 may provide the second indication to a human user of the fourth network node 140, or to another software agent, depending on the desired level of automation. The sending in this Action 603 may then enable the fourth network node 140, or the user of the fourth network node 140, to choose the most appropriate plan of the one or more plans “P”, and issuing it to the maintenance team.

Action 604

In this Action 604, the first network node 110 may obtain, from the one or more second third network nodes 130, updated one or more predictive models for the one or more second network nodes 120.

This Action may be performed similarly to Action 601.

Action 605

In this Action 605, after having obtained the updated one or more predictive models for the one or more second network nodes 120, the first network node 110, may determine updated one or more plans to maintain the one or more second network nodes 120. The determining in this Action 605 may be based on the obtained updated one or more predictive models.

This Action may be performed similarly to Action 602.

Action 606

In this Action 606, the first network node 110, may send a third indication of the determined updated one or more plans to the fourth network node 140 operating in the communications network 100.

This Action may be performed similarly to Action 603.

As may be understood from Actions 604, 605 and 606, the method iterates through these Actions, as new data may be collected, the one or more predictive models may be updated and improved, in order to updated and improve the adequacy of the one or more plans.

FIG. 7 is a schematic illustration depicting an example of the first network node 110, which may be referred to as an Optimizer “O”. As depicted in FIG. 7, the first network node 110 may use models emi, mki and lpi as input, as well as the criticality of each of the one or more second network nodes 120, to estimate the impact of the one or more plans “P” on overall performance of the communications network 100.

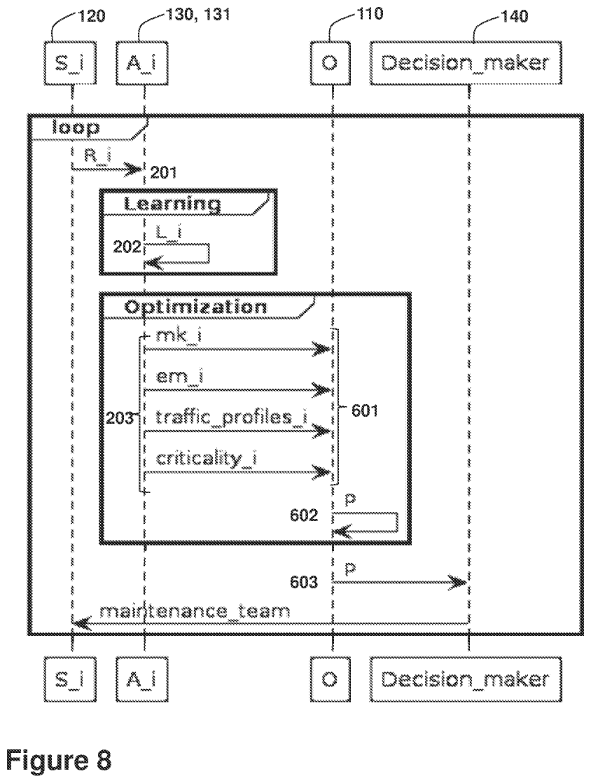

FIG. 8 is a schematic illustration of the interactions that may take place between the first network node 110, represented as “O”, the one or more second network nodes 120, represented as “S_i”, the one or more third network nodes 130, represented as “A_i”, where the third network node 131 is an example thereof, and the fourth network node 140, represented as “Decision_maker”. Each of the one or more third network nodes 130 obtains, in Action 201, from its corresponding site or respective second network node 121, 122, 123, respectively, the one or more indications of: i) the maintenance status of their respective one or more components, ii) the one or more status messages; or iii) the respective traffic load. The one or more indications may be obtained as one or more reports Ri. In Action 202, each of one or more third network nodes 130 obtains for a respective second network node 121, 122, 123, the one or more predictive models mk_i, em_i, traffic_profiles_i, as well as the criticality_i for the respective second network node 121, 122, 123 for the respective second network node 121, 122, 123, in a respective learning process L_i. In Action 203, each of the one or more third network nodes 130 sends the obtained one or more predictive models to the first network node 110. In Action 601, the first network node 110 obtains, respectively, from each of the one or more third network nodes 130 the one or more predictive models. In Action 602, the first network node 110 determines the one or more plans “P” to maintain the one or more second network nodes 120 based on the obtained one or more predictive models. In Action 603, the first network node 110 sends the second indication of the determined one or more plans to the fourth network node 140, which chooses the most appropriate plan of the one or more plans “P”, and issues it to the maintenance team. The maintenance team then maintains the one or more second network nodes 120 according to the chosen plan.

As a summary overview of the description provided, expressed in other terms, embodiments herein may be understood to be drawn to a method for learning key information about the impact of maintenance at RBS sites. Embodiments herein may be understood to involve a multi-agent system, where each agent may be assigned to take care of a single site Si, and a single agent may be assigned to optimize important KPIs.

Embodiments herein may be understood to be draw to a procedure for learning the expected impact of performing maintenance on discrete equipment at specific sites. This procedure may be broken down into two distinct learning processes, e.g., learning emi and mki may be separate procedures, which makes it easier to build the training dataset for each.

Certain embodiments may provide one or more of the following technical advantage(s). The advantages of the embodiments herein are mainly in terms of efficiency, which may be summarized as follows. Embodiments herein may be understood to reduce expected negative impacts on the communications network 100 due to maintenance. According to some embodiments herein, the usage of agents such as the one or more third network nodes 130 enables learning, in an automatic fashion, of the one or more predictive models related to the RBS performance and equipment status based on reports provided by the site. The learning system may process a large amount of data, update the model continuously and use historical information of the communications network 100.

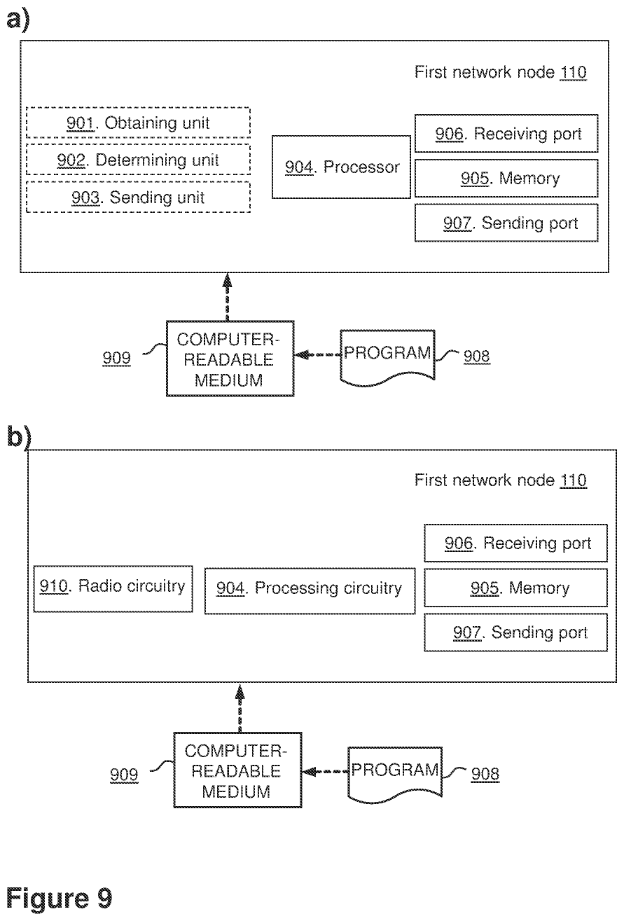

FIG. 9 depicts two different examples in panels a) and b), respectively, of the arrangement that the first network node 110 may comprise to perform the method actions described above in relation to FIG. 6. In some embodiments, the first network node 110 may comprise the following arrangement depicted in FIG. 9a. The first network node 110 is configured to handle the maintenance of the one or more second network nodes 120. The first network node 110 and the one or more second network nodes 120 are further configured to operate in the communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 110, and will thus not be repeated here. For example, the multi-objective optimization algorithm may be e.g., NSGA2 or SPEA2. In FIG. 9, optional modules are indicated with dashed boxes.

The first network node 110 is configured to, e.g. by means of an obtaining unit 901 within the first network node 110 configured to, obtain, respectively, from each of one or more third network nodes 130 configured to operate in the communications network 100, and for a respective second network node 121, 122, 123 of the one or more second network nodes 120, the one or more predictive models for each of: a) the performance of the respective second network node 121, 122, 123, wherein the one or more first predictive models of the performance are configured to be based on one or more status messages configured to be obtained, from the respective second network node 121, 122, 123, and the one or more first predictive models of the performance are configured to indicate at least one of: the number of data transmission failures, the number of dropped calls, or the area of blind spots; and b) the traffic load of the respective second network node 121, 122, 123.

The first network node 110 is configured to, e.g. by means of a determining unit 902 within the first network node 110 configured to, determine the one or more plans to maintain the one or more second network nodes 120. The determining may be configured to be based on the one or more predictive models configured to be obtained.

In some embodiments, the one or more predictive models may be configured to further comprise one or more second predictive models for: iii) the status messages configured to be received from the respective second network node 121, 122, 123. The one or more second predictive models for the status messages may be configured to be based on the maintenance status of one or more components of the respective second network node 121, 122, 123. The one or more plans configured to be determined may be configured to comprise the one or more first indications of the set of the one or more components requiring maintenance.

In some embodiments, the determining of the one or more plans may be further configured to be based on one or more of: a) the geographical position of the one or more second network nodes 120, b) the position of the one or more second network nodes 120 relative, respectively, to the position of other radio network nodes operating in the communications network 100; or c) the criticality of the one or more second network nodes 120.

In some embodiments, the number of data transmission failures, or the number of dropped calls, may be configured to be based on the first weighted sum of the number of data transmission failures, or of the number of dropped calls, at each of the one or more second network nodes 120 during the first period of time. The first weighted sum may be configured to be based on the criticality of the one or more second network nodes 120.

In some embodiments, the area of blind spots may be configured to be based on the second weighted sum of blind spots at each of the one or more second network nodes 120 the second period of time. The second weighted sum may be configured to be based on the criticality of the one or more second network nodes 120.

In some embodiments, based on the one or more predictive models configured to be obtained, the determining may be configured to comprise applying the multi-objective optimization algorithm. The application of the multi-objective optimization algorithm may be configured to simultaneously: a) minimize the number of data transmission failures, or the number of dropped calls, and the area of blind spots; and b) maximize the traffic load.

The first network node 110 may be further configured to, e.g. by means of a sending unit 903 within the first network node 110 configured to, send the second indication of the one or more plans configured to be determined to the fourth network node 140 configured to operate in the communications network 100.

In some embodiments, the first network node 110 may be further configured to, e.g. by means of the obtaining unit 901 within the first network node 110 configured to, obtain, from the one or more second third network nodes 130, the updated one or more predictive models for the one or more second network nodes 120.

In some embodiments, the first network node 110 may be further configured to, e.g. by means of the determining unit 902 within the first network node 110 configured to, determine the updated one or more plans to maintain the one or more second network nodes 120. The determining of the updated one or more plans may be configured to be based on the updated one or more predictive models configured to be obtained.

In some embodiments, the first network node 110 may be further configured to, e.g. by means of the sending unit 903 within the first network node 110 configured to, send the third indication of the updated one or more plans configured to be determined to the fourth network node 140 configured to operate in the communications network 100.

Other modules may be comprised in the first network node 110.

The embodiments herein in the first network node 110 may be implemented through one or more processors, such as a processor 904 in the first network node 110 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 110. One such carrier may be in the form of a CD ROM disc. It is however feasible with other data carriers such as a memory stick. The computer program code may furthermore be provided as pure program code on a server and downloaded to the first network node 110.

The first network node 110 may further comprise a memory 905 comprising one or more memory units. The memory 905 is arranged to be used to store obtained information, store data, configurations, schedulings, and applications etc. to perform the methods herein when being executed in the first network node 110.

In some embodiments, the first network node 110 may receive information from, e.g., the one or more third network nodes 130, through a receiving port 906. In some embodiments, the receiving port 906 may be, for example, connected to one or more antennas in first network node 110. In other embodiments, the first network node 110 may receive information from another structure in the communications network 100 through the receiving port 906. Since the receiving port 906 may be in communication with the processor 904, the receiving port 906 may then send the received information to the processor 904. The receiving port 906 may also be configured to receive other information.

The processor 904 in the first network node 110 may be further configured to transmit or send information to e.g., the one or more third network nodes 130, or another structure in the communications network 100, through a sending port 907, which may be in communication with the processor 904, and the memory 905.

Those skilled in the art will also appreciate that the obtaining unit 901, the determining unit 902, and the sending unit 903, described above may refer to a combination of analog and digital modules, and/or one or more processors configured with software and/or firmware, e.g., stored in memory, that, when executed by the one or more processors such as the processor 904, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, any of the units 901-903 described above may be respectively implemented as the processor 904 of the first network node 110, or an application running on such processor.

Thus, the methods according to the embodiments described herein for the first network node 110 may be respectively implemented by means of a computer program 908 product, comprising instructions, i.e., software code portions, which, when executed on at least one processor 904, cause the at least one processor 904 to carry out the actions described herein, as performed by the first network node 110. The computer program 908 product may be stored on a computer-readable storage medium 909. The computer-readable storage medium 909, having stored thereon the computer program 908, may comprise instructions which, when executed on at least one processor 904, cause the at least one processor 904 to carry out the actions described herein, as performed by the first network node 110. In some embodiments, the computer-readable storage medium 909 may be a non-transitory computer-readable storage medium, such as a CD ROM disc, or a memory stick. In other embodiments, the computer program 908 product may be stored on a carrier containing the computer program 908 just described, wherein the carrier is one of an electronic signal, optical signal, radio signal, or the computer-readable storage medium 909, as described above.

The first network node 110 may comprise an interface unit to facilitate communications between the first network node 110 and other nodes or devices, e.g., the first network node 110, or any of the other nodes. In some particular examples, the interface may, for example, include a transceiver configured to transmit and receive radio signals over an air interface in accordance with a suitable standard.

In other embodiments, the first network node 110 may comprise the following arrangement depicted in FIG. 9b. The first network node 110 may comprise a processing circuitry 904, e.g., one or more processors such as the processor 904, in the first network node 110 and the memory 905. The first network node 110 may also comprise a radio circuitry 910, which may comprise e.g., the receiving port 906 and the sending port 907. The processing circuitry 904 may be configured to, or operable to, perform the method actions according to FIG. 6, and/or FIG. 8, in a similar manner as that described in relation to FIG. 9a. The radio circuitry 910 may be configured to set up and maintain at least a wireless connection any of the one or more third network nodes 130. Circuitry may be understood herein as a hardware component.

Hence, embodiments herein also relate to the first network node 110 operative to handle the maintenance of the one or more second network nodes 120, the first network node 110 being operative to operate in the communications network 100. The first network node 110 may comprise the processing circuitry 904 and the memory 905, said memory 905 containing instructions executable by said processing circuitry 904, whereby the first network node 110 is further operative to perform the actions described herein in relation to the first network node 110, e.g., in FIG. 6, and/or FIG. 8.

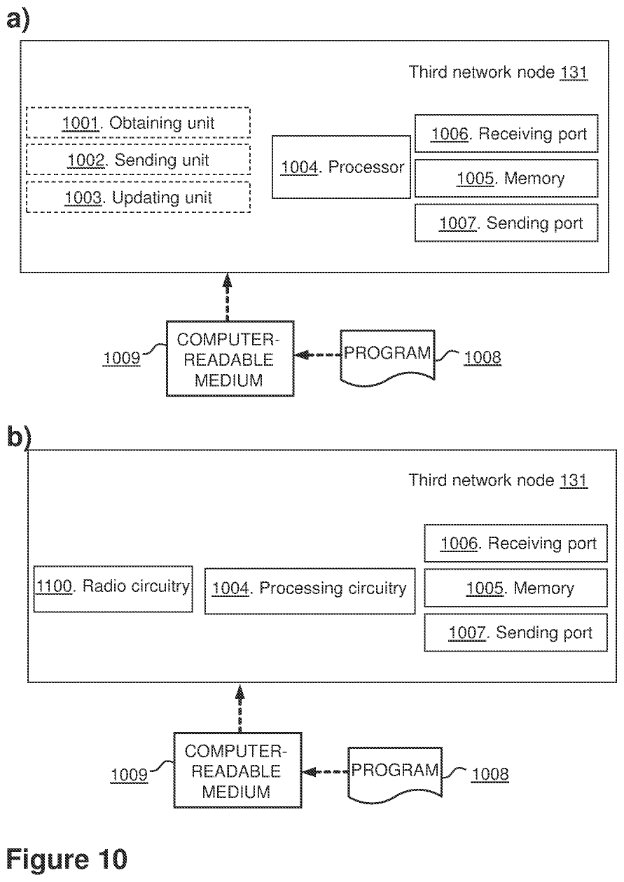

FIG. 10 depicts two different examples in panels a) and b), respectively, of the arrangement that the third network node 131 may comprise to perform the method actions described above in relation to FIG. 2. In some embodiments, the third network node 131 may comprise the following arrangement depicted in FIG. 10a.

The third network node 131 is configured to handle the maintenance of the second network node 121. The third network node 131 and the second network node 121 are further configured to operate in the communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the third network node 131, and will thus not be repeated here. For example, send to the first network node 110 may be configured to be implemented e.g., via the first link 161. In FIG. 10, optional modules are indicated with dashed boxes.

The third network node 131 is configured to, e.g. by means of an obtaining unit 1001 within the third network node 131 configured to, obtain the one or more predictive models for each of: a) the performance of the second network node 121, wherein the one or more first predictive models of the performance are configured to be based on one or more status messages obtained from the second network node 121, and the one or more first predictive models of the performance indicate at least one of: the a number of data transmission failures, the number of dropped calls, or the area of blind spots, and the traffic load of the second network node 121.

The third network node 131 is further configured to, e.g. by means of a sending unit 1002 within the third network node 131 configured to, send the one or more predictive configured to be obtained models to the first network node 110 configured to operate in the communications network 100.

In some embodiments, the one or more predictive models may be further configured to comprise the one or more second predictive models for the status messages configured to be received from the second network node 121. The one or more second predictive models for the status messages may be configured to be based on the maintenance status of the one or more components of the second network node 121.

In some embodiments, the third network node 131 may be further configured to, e.g. by means of the obtaining unit 1001 within the third network node 131 configured to, obtain, from the second network node 121 the one or more indications of: i) the maintenance status of one or more components of the second network node 121, ii) the one or more status messages configured to be received from the second network node 121; or c) the traffic load of the second network node 121.

In some embodiments, the third network node 131 may be further configured to, e.g. by means of the obtaining unit 1001 within the third network node 131 configured to, obtain, from the second network node 121 the one or more further indications of: i) the maintenance status of the one or more components of the second network node 121, ii) the one or more status messages configured to be received from the second network node 121; or iii) the traffic load of the second network node 121.

The third network node 131 may be further configured to, e.g. by means of an updating unit 1003 within the third network node 131 configured to, update the one or more predictive models configured to be obtained with the one or more further indications configured to be obtained.

In some embodiments, the third network node 131 may be further configured to, e.g. by means of the sending unit 1002 within the third network node 131 configured to, send the one or more predictive models configured to be updated to the first network node 110.

Other modules may be comprised in the third network node 131.

The embodiments herein in the third network node 131 may be implemented through one or more processors, such as a processor 1004 in the third network node 131 depicted in FIG. 10a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third network node 131. One such carrier may be in the form of a CD ROM disc. It is however feasible with other data carriers such as a memory stick. The computer program code may furthermore be provided as pure program code on a server and downloaded to the third network node 131.

The third network node 131 may further comprise a memory 1005 comprising one or more memory units. The memory 1005 is arranged to be used to store obtained information, store data, configurations, schedulings, and applications etc. to perform the methods herein when being executed in the third network node 131.

In some embodiments, the third network node 131 may receive information from, e.g., the first network node 110, or the second network node 121, through a receiving port 1006. In some embodiments, the receiving port 1006 may be, for example, connected to one or more antennas in third network node 131. In other embodiments, the third network node 131 may receive information from another structure in the communications network 100 through the receiving port 1006. Since the receiving port 1006 may be in communication with the processor 1004, the receiving port 1006 may then send the received information to the processor 1004. The receiving port 1006 may also be configured to receive other information.

The processor 1004 in the third network node 131 may be further configured to transmit or send information to e.g., the first network node 110, or the second network node 121, any of the wireless devices in the plurality of third wireless devices 150, the second wireless device 132, or another structure in the communications network 100, through a sending port 1007, which may be in communication with the processor 1004, and the memory 1005.

Those skilled in the art will also appreciate that the obtaining unit 1001, the sending unit 1002, and the updating unit 1003 described above may refer to a combination of analog and digital modules, and/or one or more processors configured with software and/or firmware, e.g., stored in memory, that, when executed by the one or more processors such as the processor 1004, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, any of the units 1001-1003 described above may be respectively implemented as the processor 1004 of the third network node 131, or an application running on such processor.

Thus, the methods according to the embodiments described herein for the third network node 131 may be respectively implemented by means of a computer program 1008 product, comprising instructions, i.e., software code portions, which, when executed on at least one processor 1004, cause the at least one processor 1004 to carry out the actions described herein, as performed by the third network node 131. The computer program 1008 product may be stored on a computer-readable storage medium 1009. The computer-readable storage medium 1009, having stored thereon the computer program 1008, may comprise instructions which, when executed on at least one processor 1004, cause the at least one processor 1004 to carry out the actions described herein, as performed by the third network node 131. In some embodiments, the computer-readable storage medium 1009 may be a non-transitory computer-readable storage medium, such as a CD ROM disc, or a memory stick. In other embodiments, the computer program 1008 product may be stored on a carrier containing the computer program 1008 just described, wherein the carrier is one of an electronic signal, optical signal, radio signal, or the computer-readable storage medium 1009, as described above.

The third network node 131 may comprise a communication interface configured to facilitate communications between the third network node 131 and other nodes or devices, e.g., the first network node 110, or the second network node 121. The interface may, for example, include a transceiver configured to transmit and receive radio signals over an air interface in accordance with a suitable standard.

In other embodiments, the third network node 131 may comprise the following arrangement depicted in FIG. 10b. The third network node 131 may comprise a processing circuitry 1004, e.g., one or more processors such as the processor 1004, in the third network node 131 and the memory 1005. The third network node 131 may also comprise a radio circuitry 1100, which may comprise e.g., the receiving port 1006 and the sending port 1007. The processing circuitry 1004 may be configured to, or operable to, perform the method actions according to FIG. 2, and/or FIG. 8, in a similar manner as that described in relation to FIG. 10a. The radio circuitry 1100 may be configured to set up and maintain at least a wireless connection with the first network node 110, or the second network node 121. Circuitry may be understood herein as a hardware component.

Hence, embodiments herein also relate to the third network node 131 operative to handle the maintenance of the second network node 121, the third network node 131 being operative to operate in the communications network 100. The third network node 131 may comprise the processing circuitry 1004 and the memory 1005, said memory 1005 containing instructions executable by said processing circuitry 1004, whereby the third network node 131 is further operative to perform the actions described herein in relation to the third network node 131, e.g., in FIG. 2, and/or FIG. 8.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

1. A method, performed by a first network node, for handling a maintenance of one or more second network nodes, the first network node and the one or more second network nodes operating in a communications network, the method comprising:
obtaining, respectively, from each of one or more third network nodes operating in the communications network, and for a respective second network node of the one or more second network nodes, one or more predictive models for each of:
a. a performance of the respective second network node, wherein one or more first predictive models of the performance are based on one or more status messages obtained, from the respective second network node, and the one or more first predictive models of the performance indicate at least one of: a number of data transmission failures, a number of dropped calls, or an area of blind spots, and
b. a traffic load of the respective second network node; and
determining one or more plans to maintain the one or more second network nodes, the determining being based on the obtained one or more predictive models.

2. The method according to claim 1, wherein the one or more predictive models further comprise one or more second predictive models for:
c. status messages received from the respective second network node, the one or more second predictive models for the status messages being based on a maintenance status of one or more components of the respective second network node,
and wherein the determined one or more plans comprise one or more first indications of a set of the one or more components requiring maintenance.

3. The method according to claim 1, wherein the determining of the one or more plans is further based on one or more of:
a. a geographical position of the one or more second network nodes,
b. a position of the one or more second network nodes relative, respectively, to a position of other radio network nodes operating in the communications network; or
c. a criticality of the one or more second network nodes.

4. The method according to claim 1, wherein the number of data transmission failures, or the number of dropped calls, is based on a first weighted sum of the number of data transmission failures, or of the number of dropped calls, at each of the one or more second network nodes during a first period of time, wherein the first weighted sum is based on a criticality of the one or more second network nodes.

5. The method according to claim 1, wherein the area of blind spots is based on a second weighted sum of blind spots at each of the one or more second network nodes during a second period of time, wherein the second weighted sum is based on a criticality of the one or more second network nodes.

6. The method according to claim 1, wherein, based on the obtained one or more predictive models, the determining comprises applying a multi-objective optimization algorithm, wherein the application of the multi-objective optimization algorithm simultaneously:
a. minimizes the number of data transmission failures, or the number of dropped calls, and the area of blind spots; and
b. maximizes the traffic load.

7. (canceled)

8. (canceled)

9. A method, performed by a third network node, for handling a maintenance of a second network node, the third network node and the second network node operating in a communications network, the method comprising:
obtaining one or more predictive models for each of:
a. a performance of the second network node, wherein one or more first predictive models of the performance are based on one or more status messages obtained from the second network node, and the one or more first predictive models of the performance indicate at least one of: a number of data transmission failures, a number of dropped calls, or an area of blind spots, and
b. a traffic load of the second network node; and
sending the obtained one or more predictive models to a first network node operating in the communications network.

10. The method according to claim 9, wherein the one or more predictive models further comprise one or more second predictive models for:
c. status messages received from the second network node, the one or more second predictive models for the status messages being based on a maintenance status of one or more components of the second network node.

11. (canceled)

12. The method according to claim 9, further comprising:
obtaining, from the second network node one or more further indications of:
i. the maintenance status of the one or more components of the second network node,
ii. the one or more status messages received from the second network node; or
iii. the traffic load of the second network node, and
updating the obtained one or more predictive models with the obtained one or more further indications.

13. The method according to claim 12, further comprising:
sending the updated one or more predictive models to the first network node.

14. A first network node configured to handle a maintenance of one or more second network nodes, the first network node and the one or more second network nodes being configured to operate in a communications network, the first network node being further configured to:
obtain, respectively, from each of one or more third network nodes configured to operate in the communications network, and for a respective second network node of the one or more second network nodes, one or more predictive models for each of:
a. a performance of the respective second network node, wherein one or more first predictive models of the performance are configured to be based on one or more status messages configured to be obtained, from the respective second network node, and the one or more first predictive models of the performance are configured to indicate at least one of: a number of data transmission failures, a number of dropped calls, or an area of blind spots, and
b. a traffic load of the respective second network node; and
determine one or more plans to maintain the one or more second network nodes, the determining being configured to be based on the one or more predictive models configured to be obtained.

15. The first network node according to claim 14, wherein the one or more predictive models are configured to further comprise one or more second predictive models for:
c. status messages configured to be received from the respective second network node, the one or more second predictive models for the status messages being configured to be based on a maintenance status of one or more components of the respective second network node,
and wherein the one or more plans configured to be determined are configured to comprise one or more first indications of a set of the one or more components requiring maintenance.

16. The first network node according to claim 14, wherein the determining of the one or more plans is further configured to be based on one or more of:
a. a geographical position of the one or more second network nodes,
b. a position of the one or more second network nodes relative, respectively, to a position of other radio network nodes operating in the communications network; or
c. a criticality of the one or more second network nodes.

17. The first network node according to claim 14, wherein the number of data transmission failures, or the number of dropped calls, is configured to be based on a first weighted sum of the number of data transmission failures, or of the number of dropped calls, at each of the one or more second network nodes during a first period of time, wherein the first weighted sum is configured to be based on a criticality of the one or more second network nodes.

18. The first network node according to claim 14, wherein the area of blind spots is configured to be based on a second weighted sum of blind spots at each of the one or more second network nodes during a second period of time, wherein the second weighted sum is configured to be based on a criticality of the one or more second network nodes.

19. The first network node according to claim 14, wherein based on the one or more predictive models configured to be obtained, the determining is configured to comprise applying a multi-objective optimization algorithm, wherein the application of the multi-objective optimization algorithm is configured to simultaneously:
a. minimize the number of data transmission failures, or the number of dropped calls, and the area of blind spots; and
b. maximize the traffic load.

20. (canceled)

21. (canceled)

22. A third network node configured to handle a maintenance of a second network node, the third network node and the second network node being configured to operate in a communications network, the third network node being further configured to:
obtain one or more predictive models for each of:
a. a performance of the second network node, wherein one or more first predictive models of the performance are configured to be based on one or more status messages obtained from the second network node, and the one or more first predictive models of the performance indicate at least one of: a number of data transmission failures, a number of dropped calls, or an area of blind spots, and
b. a traffic load of the second network node; and
send the one or more predictive models configured to be obtained to a first network node configured to operate in the communications network.

23. The third network node according to claim 22, wherein the one or more predictive models are further configured to comprise one or more second predictive models for:
c. status messages configured to be received from the second network node, the one or more second predictive models for the status messages being configured to be based on a maintenance status of one or more components of the second network node.

24. (canceled)

25. The third network node according to claim 22, being further configured to:
obtain, from the second network node one or more further indications of:
i. the maintenance status of the one or more components of the second network node,
ii. the one or more status messages configured to be received from the second network node; or
iii. the traffic load of the second network node, and
update the one or more predictive models configured to be obtained with the one or more further indications configured to be obtained.

26. The third network node according to claim 25, being further configured to:
send the one or more predictive models configured to be updated to the first network node.
